(19) United States
(12) Patent Application Publication
(10) Pub. No.: US 2025/0225644 A1
(43) Pub. Date: Jul. 10, 2025

(54) INFORMATION PROCESSING APPARATUS, INFORMATION PROCESSING METHOD, AND NON-TRANSITORY COMPUTER-READABLE STORAGE MEDIUM STORING A COMPUTER PROGRAM

(71) Applicant: CANON KABUSHIKI KAISHA, Tokyo (JP)

(72) Inventor: Shinichi MITSUMOTO, Saitama (JP)

(21) Appl. No.: 18/985,114

(22) Filed: Dec. 18, 2024

(30) Foreign Application Priority Data
Jan. 10, 2024 (JP) 2024-002045

(51) Int. Cl. G06T 7/00; G06T 7/10; G06V 10/764

(52) U.S. Cl. CPC G06T 7/0008; G06T 7/10; G06V 10/764; G06T 2207/30132

(57) ABSTRACT

An information processing apparatus comprising: one or more processors; and one or more memories including instructions that, when executed by the one or more processors, cause the information processing apparatus to: acquire first deformation data indicating a deformation included in a first inspection image obtained by capturing a first region, and second deformation data indicating a deformation included in a second inspection image obtained by capturing a second region including at least a part of the first region at a timing newer than a timing at which the first inspection image is captured; calculate difference deformation data indicating a difference between the first deformation data and the second deformation data; and create learning data for causing, to learn, a model that predicts an appearance of the deformation based on the difference deformation data.

### BACKGROUND OF THE INVENTION

### Field of the Invention

The present invention relates to an information processing apparatus, an information processing method, and a non-transitory computer-readable storage medium storing a computer program.

### Description of the Related Art

In recent years, image-based inspection has been widely performed, in which deformations that are damages such as cracking are extracted by manual tracing or an image recognition technique from an image obtained by capturing a structure made of concrete or the like (Izumi et al., “Automatic Crack Detection by Deep Learning Model using an Attention Mechanisms”, Artificial Intelligence and Data Science, 2021 Volume 2 Issue J2 Pages 545-555, [Searched on Dec. 23, 2023], Internet, <URL: https://www.jstage.jst.go.jp/article/jsceiii/2/J2/2_545/_article/-char/ja>, hereinafter referred to as Izumi Document), and soundness is determined based on the position, scale, and quantity of the deformations.

Furthermore, according to Japanese Patent Laid-Open No 2021-18233 discloses a method for creating a distortion distribution from an image of a known initial test body and an image of a test body that has a distortion, and predicting an appearance of a distortion.

However, the method of Japanese Patent Laid-Open No. 2021-18233 makes a determination based on a distortion distribution obtained for a known test body, and does not use an image as an input. It is difficult to generate learning data for causing, to learn, a learning model that predicts an appearance of a damage based on a captured image.

### SUMMARY OF THE INVENTION

The present invention has been made in view of the above problems, and provides an information processing apparatus, an information processing method, and a non-transitory computer-readable storage medium storing a computer program that can create learning data for causing, to learn, a learning model for predicting an appearance of a deformation even with an unknown captured image.

An information processing apparatus comprising: one or more processors; and one or more memories including instructions that, when executed by the one or more processors, cause the information processing apparatus to: acquire first deformation data indicating a deformation included in a first inspection image obtained by capturing a first region, and second deformation data indicating a deformation included in a second inspection image obtained by capturing a second region including at least a part of the first region at a timing newer than a timing at which the first inspection image is captured; calculate difference deformation data indicating a difference between the first deformation data and the second deformation data; and create learning data for causing, to learn, a model that predicts an appearance of the deformation based on the difference deformation data.

Further features of the present invention will become apparent from the following description of exemplary embodiments (with reference to the attached drawings).

### BRIEF DESCRIPTION OF THE DRAWINGS

FIG. 1 is a block diagram illustrating an example of a hardware configuration of an information processing apparatus.

FIG. 2 is a view illustrating an example of a deformation data table.

FIG. 3 is a view illustrating an example of a superimposed image in which deformation data is superimposed on an inspection image.

FIG. 4 is a view illustrating an example of a user screen of a learning data creation application.

FIG. 5 is a view illustrating an example of a flowchart of processing of a learning data creation application.

FIG. 6A illustrates first deformation data 601.

FIG. 6B illustrates expansion deformation data 611, which is an expansion range obtained by expanding the first deformation data 601 by an expansion width D.

FIG. 6C illustrates a state in which the expansion deformation data 611 is superimposed on second deformation data 650 including a line segment 651 to the line segment 655.

FIG. 6D is a view illustrating that the second deformation data 650 within the range of the expansion deformation data 611 is treated as deformation data that matches in two different timings, and deformation data outside the expansion range is treated as difference deformation data.

FIG. 7A illustrates a deformation data table 701 in which the deformation data 601 of FIG. 6A is exemplified as a deformation ID Cb901.

FIG. 7B illustrates a deformation data table 711 of a matching part exemplifying a case where the deformation ID of the deformation data 671 of the matching part in FIG. 6D is Cbm901.

FIG. 7C illustrates a difference deformation data table 721 exemplifying a case where the deformation IDs of deformation data 672 and deformation data 673 in FIG. 6D are Cbx901_1 and Cbx901_2, respectively.

FIG. 8 is a view illustrating an example of a learning data table in a first embodiment.

FIG. 9 is a view illustrating an example of a confirmation screen of learning data in the first embodiment.

FIG. 10 is a view illustrating an example in which an image obtained by superimposing difference deformation data on an inspection image in a second embodiment is divided.

FIG. 11 is a view illustrating an example of a learning data table in the second embodiment.

FIG. 12 is a view illustrating an example of a confirmation screen of learning data in the second embodiment.

FIG. 13 is a view illustrating an example of a learning data table in a third embodiment.

FIG. 14 is a view illustrating an example of a confirmation screen of learning data in the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, a computer operates as an information processing apparatus. When a captured image is input, the information processing apparatus of the present embodiment creates learning data for predicting whether a deformation will appear in the future. The information processing apparatus of the present embodiment creates learning data for predicting an appearance of a deformation using a difference part between deformation data in two different timings and an image captured in an older timing. In the present embodiment, an example in which information on whether or not a deformation appears in an image is created as learning data will be described.

Note that deformations are cracks or the like generated on concrete surfaces due to damage, deterioration, or other factors of concrete structures such as automobile exclusive roads, bridges, tunnels, or dams, and a crack is a linear damage having a start point, an end point, a length, and a width generated on a wall surface or the like of the structure due to aging deterioration, an impact of an earthquake, or the like.

### Hardware Configuration

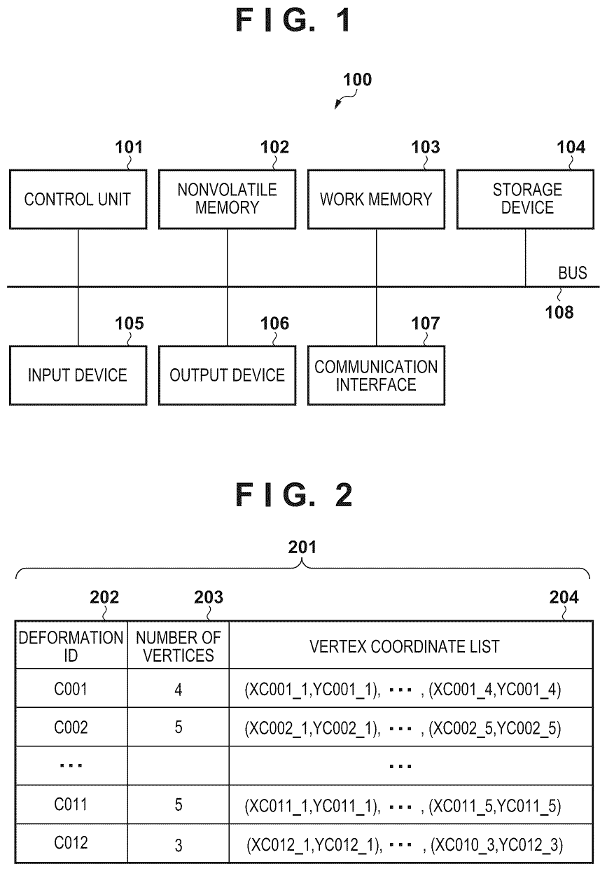

First, the hardware configuration of the information processing apparatus of the present embodiment will be described with reference to FIG. 1. FIG. 1 is a block diagram illustrating the hardware configuration of an information processing apparatus 100 of the present embodiment.

In the present embodiment, a computer operates as the information processing apparatus 100. Note that the processing of the information processing apparatus of the present embodiment may be implemented by a single computer, or may be implemented by distributing functions to a plurality of computers as necessary. The plurality of computers are communicatively connected to each other.

The information processing apparatus 100 includes a control unit 101, a nonvolatile memory 102, a work memory 103, a storage device 104, an input device 105, an output device 106, a network interface 107, and a system bus 108.

The control unit 101 integrally controls the entire information processing apparatus 100. The control unit 101 includes at least any of arithmetic processing processors such as a central processing unit (CPU), a micro processing unit (MPU), a graphics processing unit (GPU), and a quantum processing unit (QPU).

The nonvolatile memory 102 is, for example, a read only memory (ROM). The nonvolatile memory 102 stores data such as programs and parameters to be executed by a processor of the control unit 101. Here, the program includes a program for executing learning data creation processing described later.

The work memory 103 is, for example, a random access memory (RAM). The work memory 103 temporarily stores data such as programs and parameters supplied from an external apparatus or the like by the control unit 101 or the like.

The storage device 104 is a nonvolatile storage apparatus built in the information processing apparatus 100 or a nonvolatile storage apparatus detachably connected to the information processing apparatus 100. The storage device 104 is, for example, a hard disk drive (HDD) including a semiconductor memory or a magnetic disk, a solid state drive (SSD), a memory card, or the like. The storage device 104 includes a storage medium including a disk drive that reads/writes data from/to an optical disk such as a DVD or a Blu-ray Disc (registered trademark).

The input device 105 is an operation member such as a mouse, a keyboard, or a touch panel that receives a user operation. The input device 105 outputs an operation instruction received from a user to the control unit 101.

The output device 106 is a display apparatus such as a display and a monitor including a liquid crystal display and an organic electro luminescence (EL). The output device 106 displays images such as data held by the information processing apparatus 100 and data supplied from an external apparatus.

The network interface 107 is communicatively connected to any network such as the Internet and a local area network (LAN).

The system bus 108 connects the control unit 101, the nonvolatile memory 102, the work memory 103, the storage device 104, the input device 105, the output device 106, and the network interface 107 constituting the information processing apparatus 100 so as to be able to exchange data. The system bus 108 includes an address bus, a data bus, and a control bus.

The nonvolatile memory 102 or the storage device 104 stores an operating system (OS) that is basic software executed by the control unit 101 and an application that implements applied functions in cooperation with this OS. In the present embodiment, the nonvolatile memory 102 or the storage device 104 stores an application for the information processing apparatus 100 to implement learning data creation processing described later.

The processing of the information processing apparatus 100 of the present embodiment is implemented by reading software provided by an application. The application includes software for using basic functions of the OS installed in the information processing apparatus 100. The OS of the information processing apparatus 100 may have software for implementing the processing in the present embodiment.

Hereinafter, in the first embodiment, an embodiment in which information of two classes of whether or not a deformation appears in an image is created as learning data will be described.

### Deformation Data

In the present embodiment, a deformation is expressed by vector data, and an example of a case where the deformation is a crack will be described. The deformation data representing deformation as vector data includes information acquired from an inspection image obtained by capturing an inspection target, and is represented in a format as illustrated in FIG. 2 described later. Each deformation data is input by the user tracing an image with a tablet or the like, automatically generated by image analysis processing or the like, or input by a combination thereof. The image analysis processing may be executed using a learning model created by machine learning/deep learning of artificial intelligence (AI) as described in Izumi Document.

FIG. 2 is a view illustrating an example of a deformation data table 201 describing deformation data acquired from a certain inspection image.

The deformation data table 201 is a table of a plurality of deformation data in which a shape of a deformation such as each crack is expressed by a continuous polyline. Each deformation data includes a deformation ID202 for identifying each deformation data, a number of vertices 203 of the deformation such as a crack, and a vertex coordinate list 204 of the crack.

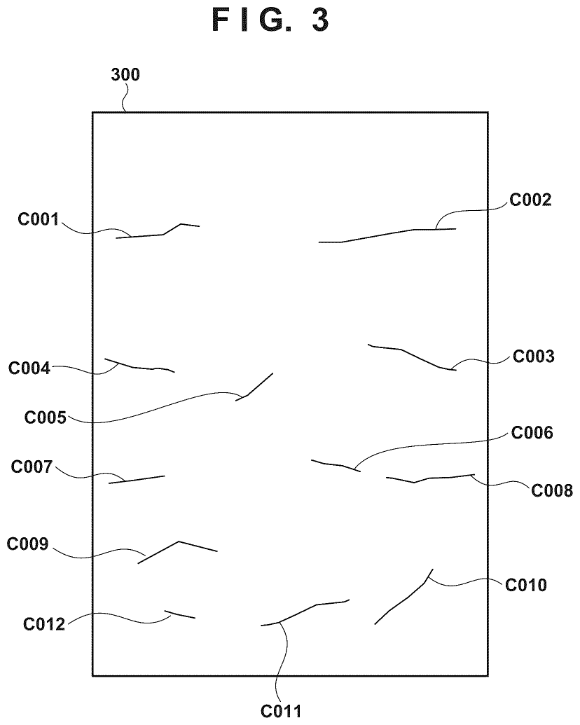

FIG. 3 is a view illustrating an example of a superimposed image 300 in which deformation data registered in the deformation data table 201 illustrated in FIG. 2 is superimposed on the inspection image.

In the superimposed image 300, C001 to C012 are cracks having deformation IDs 202 of C001 to C012 in the deformation data table 201, respectively.

### Learning Data Creation Application

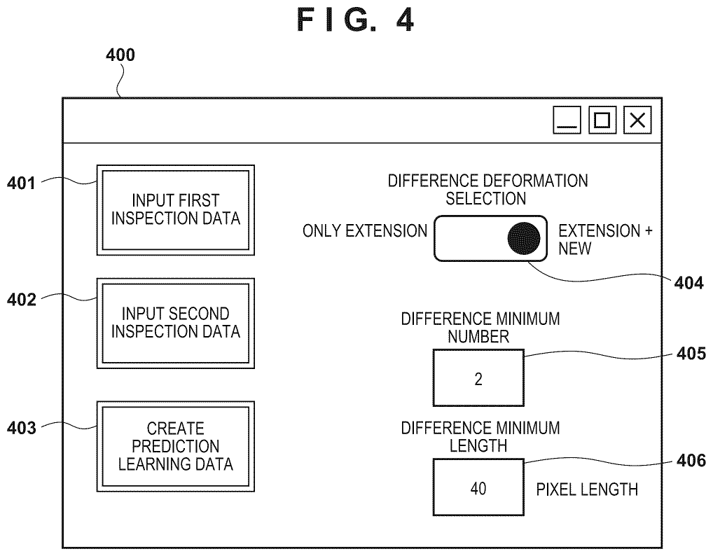

FIG. 4 is a view illustrating an example of a user screen 400 of an application for creating learning data executed in the information processing apparatus 100 of the present embodiment. The user screen 400 is what is called a graphical user interface (GUI). The user screen 400 includes a first inspection data input button 401, a second inspection data input button 402, a prediction learning data creation button 403, a difference deformation selection switch 404, a difference minimum number input region 405, and a difference minimum length input region 406.

On the user screen 400, the first inspection data input button 401 is a button for selecting an inspection image captured in a first timing. When the user operates the first inspection data input button 401 by clicking or the like, a file selection dialog (not illustrated) is displayed. The file selection dialog displays, for example, a list of any of a file name and a thumbnail of an image captured in the first timing and stored in the storage device. When the user selects any of the images displayed in the file selection dialog, the control unit 101 acquires the selected image as the first inspection image. The control unit 101 stores the first inspection image or identification information for specifying the first inspection image into the work memory 103 or the like.

The second inspection data input button 402 is a button for selecting a second inspection image captured at a second timing newer than the first timing. The second inspection image is an image obtained by capturing an inspection target region including a region at least a part of an inspection target region of the first inspection image. In the present embodiment, the second inspection image is an image obtained by capturing the same inspection target region as that of the first inspection image. When the user operates the second inspection data input button 402, the control unit 101 causes the output device 106 to display a file selection dialog (not illustrated). The file selection dialog is, for example, a screen including a list of at least any of a file name and a thumbnail of an image obtained by capturing the same inspection target region as that of the first inspection image and stored in the storage device 104 in a plurality of second timings newer than the first timing. When the user selects an image from the file selection dialog, the control unit 101 acquires the image from the storage device 104 as the second inspection image. When capturing regions of the first inspection image and the second inspection image are misaligned, the control unit 101 may correct the misalignment. The control unit 101 stores the second inspection image or identification information for specifying the second inspection image into the work memory 103 or the like.

The prediction learning data creation button 403 is a button for inputting an instruction for creation of learning data. When the user operates the prediction learning data creation button 403, the control unit 101 creates learning data.

The difference deformation selection switch 404 is a button for selecting a type of difference deformation data to be used for learning data described later. Note that although details will be described later, the difference deformation data is a difference in shape of the same deformation data in two different timings. By operating the difference deformation selection switch 404, for example, the user selects whether to use only extension difference deformation data among the difference deformation data or to use newly appearing difference deformation data in addition to the extension.

The difference minimum number input region 405 is a numerical value input region for setting, as a threshold, the minimum number of difference deformation data included in the learning data. When the difference deformation data of learning data is larger than the minimum number, the control unit 101 uses the learning data.

The difference minimum length input region 406 is a numerical value input region for setting, as a threshold, the minimum pixel length of all the difference deformation data included in the learning data. When the difference deformation data is longer than the minimum pixel length, the control unit 101 uses the learning data.

### Learning Data Creation Processing

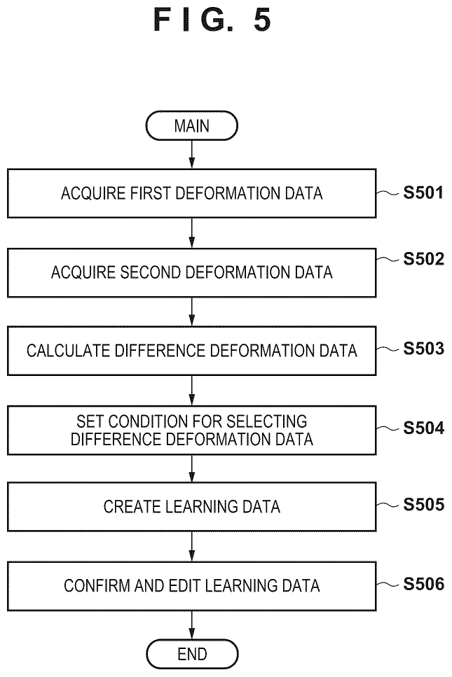

FIG. 5 is a view showing an example of a flowchart of processing of a creation application of learning data from the difference deformation data in the first embodiment. In the present embodiment, with inspection images in two different timings obtained by capturing the same place as input, difference deformation data is calculated from deformation data detected from the respective images, and learning data for prediction is created from the difference deformation data and the images.

The processing of FIG. 5 is implemented by the control unit 101 of the information processing apparatus 100 illustrated in FIG. 1 reading a program stored in the nonvolatile memory 102 or the storage device 104, developing the program in the work memory 103, and executing the program to control each component. By executing the program, the control unit 101 functions as, for example, an acquisition means that acquires an inspection image and deformation data, a calculation means that calculates difference deformation data, and a creation means that creates learning data.

In S501, the control unit 101 reads the first inspection image selected by the user with the first inspection data input button 401, and acquires the first deformation data corresponding to the first inspection image that is read. The control unit 101 may detect and acquire the first deformation data at the timing of reading the first inspection image, or may acquire the detected first deformation data associated with the first inspection image.

In S502, the control unit 101 reads the second inspection image selected by the user with the second inspection data input button 402, and acquires the second deformation data corresponding to the second inspection image that is read. Similarly to S501, the control unit 101 may detect and acquire the second deformation data at the timing of reading the second inspection image, or may acquire the detected second deformation data associated with the second inspection image.

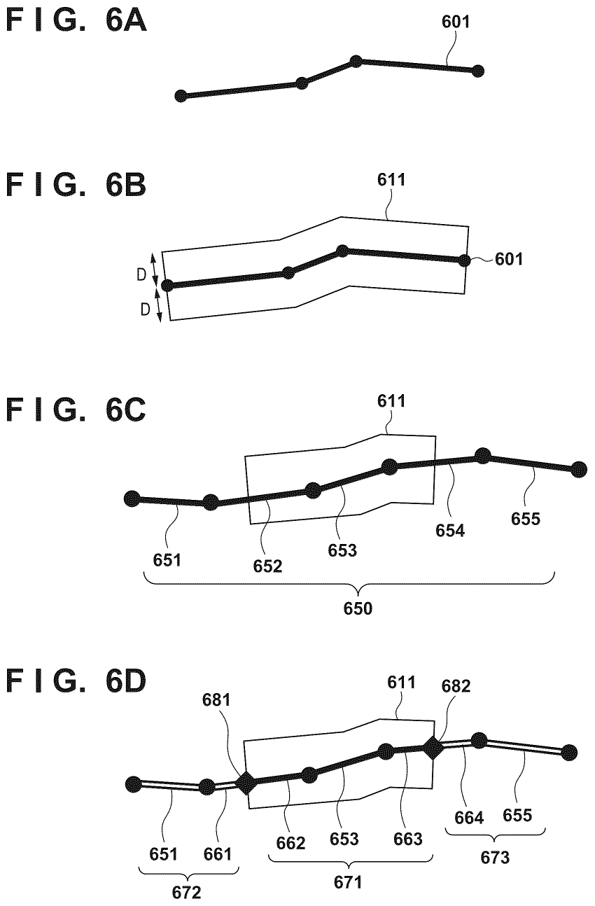

In S503, the control unit 101 calculates deformation data appearing only in the second deformation data as difference deformation data using the first deformation data acquired in S501 and the second deformation data acquired in S502. Details of a calculation method of the difference deformation data will be described later with reference to FIG. 6.

In S504, the control unit 101 sets a condition for selecting difference deformation data to be used for creation of learning data described later, among the difference deformation data calculated in S503. The control unit 101 sets a condition based on the information input by the user in the difference deformation selection switch 404, the difference minimum number input region 405, and the difference minimum length 406 of the user screen 400. Based on the condition, the control unit 101 sets a learning label of the learning data described later.

In S505, upon detecting that the user pressing the prediction learning data creation button 403, the control unit 101 creates learning data using the difference deformation data satisfying the condition set in S504.

In S506, the control unit 101 causes the user to confirm the learning data created in S505 and receives editing of the learning data from the user. For example, the control unit 101 causes the output device 106 to display the learning data, thereby causing the user to confirm and edit the learning data. The control unit 101 outputs and stores, in the work memory 103 or the storage device 104, the confirmed and edited learning data as a file.

Note that, in the present embodiment, an example has been described in which the user selects each of the first inspection image and the second inspection image, and the inspection images of two periods are separately acquired, but the selection method of the inspection image is not limited to this. For example, the information processing apparatus 100 may generate and present, to the user, a list in which the file of the first inspection image and the file of the second inspection image are associated as a pair. In this case, the information processing apparatus 100 may acquire two inspection images by causing the user to select a plurality of inspection image file names of the two timings at a time from the list.

### Calculation of Difference Deformation Data

The calculation processing of the difference deformation data in S503 will be described. FIG. 6 is a view illustrating an example of the difference calculation processing between deformation data.

FIG. 6A illustrates the first deformation data 601. FIG. 6B illustrates the expansion deformation data 611, which is an expansion range obtained by expanding the first deformation data 601 by the expansion width D. FIG. 6C illustrates a state in which the expansion deformation data 611 is superimposed on the second deformation data 650 including the line segment 651 to the line segment 655. FIG. 6D is a view illustrating that the second deformation data 650 within the range of the expansion deformation data 611 is treated as deformation data that matches in two different timings, and deformation data outside the expansion range is treated as difference deformation data.

The determination method of the overlap within and without the range may be applied with a collision determination technique widely known in the field of computer games and the like. In this case, the control unit 101 generates an intermediate point 681 and an intermediate point 682, which are switching points between matching identical deformation data and difference deformation data. For example, the control unit 101 creates expansion deformation data obtained by expanding the deformation data in a width direction. Next, the control unit 101 may generate intersections of the expansion deformation data 611 and the second deformation data 650 as the intermediate points 681 and 682. The control unit 101 divides the line segment 652 into a line segment 661 and a line segment 662 at the intermediate point 681, and divides the line segment 654 into a line segment 663 and a line segment 664 at the intermediate point 682. The control unit 101 divides the deformation data 671 in which the first deformation data and the second deformation data match each other into the line segment 662, the line segment 653, and the line segment 663. The control unit 101 generates two deformation data as difference deformation data. Specifically, the control unit 101 generates the deformation data 672 including the line segment 651 and the line segment 661, and the deformation data 673 including the line segment 664 and the line segment 655.

When dividing the second deformation data into deformation data matching the first deformation data and difference deformation data not matching the first deformation data, the control unit 101 sets the type of the difference deformation data as “extension”. In other words, when some of the second deformation data overlap the first deformation data and the second deformation data extends from the first deformation data, the control unit 101 sets the type of the difference deformation data to “extension”. On the other hand, when determining that the second deformation data not overlapping the first deformation data is difference deformation data (not illustrated), the control unit 101 sets the type of the difference deformation data as “new”. In other words, when determining that the second deformation data appears at the position where the first deformation data does not appear, the control unit 101 sets the type of the difference deformation data to “new”. The overlap mentioned here excludes a case where the second deformation data intersects the first deformation data at substantially one place.

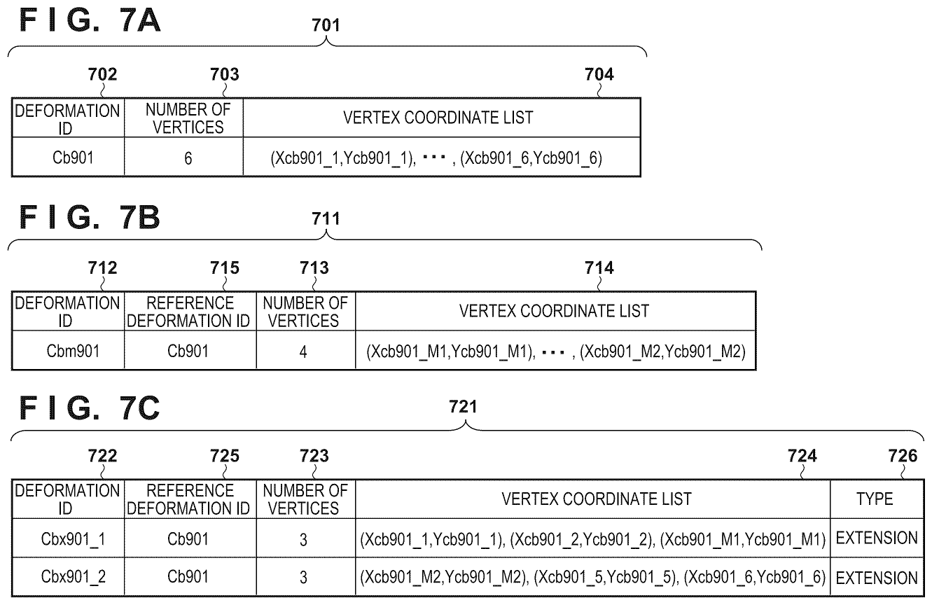

FIG. 7 illustrates a deformation data table in which deformation data and difference deformation data of a difference calculation result are in a table.

The deformation data table 701 of FIG. 7A exemplifies the deformation data 601 of FIG. 6A as the deformation ID Cb901. The deformation data table 701 has the same configuration as that of the deformation data table 201 of FIG. 2 and includes a deformation ID 702, a number of vertices 703, and a vertex coordinate list 704.

The deformation data table 711 of the matching part in FIG. 7B exemplifies a case where the deformation ID of the deformation data 671 of the matching part in FIG. 6D is Cbm901. The deformation data table 711 of the matching part includes an item of a reference deformation ID 715 in addition to the configuration of the deformation data table 701. In the example illustrated in FIG. 7B, Cb901, which is the deformation ID of FIG. 7A, is described as an ID of the deformation data that is the source of the matching deformation data.

The difference deformation data table 721 of FIG. 7C exemplifies a case where the deformation IDs of the deformation data 672 and the deformation data 673 in FIG. 6D are Cbx901_1 and Cbx901_2, respectively. In the difference deformation data table 721, an item of a type 726 is added in addition to the items in the deformation data table 711. The type 726 indicates whether the type of the difference deformation data is either “extension” or “new”.

### Learning Data

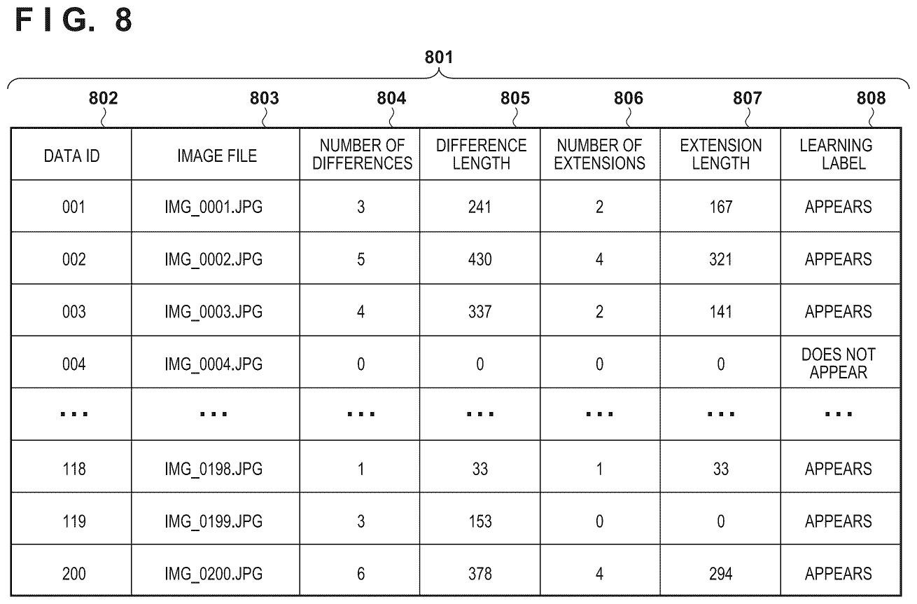

The learning data in the first embodiment calculated by the control unit 101 in S505 will be described with reference to FIG. 8. FIG. 8 is a view illustrating an example of a learning data table 801.

The learning data table 801 includes a data ID 802, an image file 803, a number of differences 804, a difference length 805, a number of extensions 806, an extension length 807, and a learning label 808.

The data ID 802 indicates an ID for identifying the learning data. The image file 803 indicates an image file name of the first inspection image. The number of differences 804 indicates the number of difference deformation IDs calculated in S503 per image file. The difference length 805 indicates a pixel length of the difference deformation data per image. The number of extensions 806 and the extension length 807 indicate the number and length of deformations indicating extension, among the number of differences 804 and the difference length 805, respectively.

The learning label 808 indicates a label for estimating and classifying prediction of the deformation. For example, any of “appears” classified when the difference deformation data appears and “does not appear” classified when no difference deformation data appears is set in the learning label 808. The control unit 101 may use, as the learning data, data in which the learning label is set to “appears”. In other words, the control unit 101 assigns learning labels in units of images (here, units of first inspection images) and classifies the images, and sets whether or not to use the images as learning data. The control unit 101 sets the learning label 808 based on the condition of the difference deformation data used in S504. For example, in a case of only extension in the difference deformation selection switch 404, the number of extensions and the extension length of the image files having the data ID “119” are 0, and thus the control unit 101 changes the learning label from “appears” to “does not appear”. When determining that the number of differences of the difference deformation data calculated for each of the difference deformation data corresponding to the first inspection image does not satisfy the minimum number input to the difference minimum number input region 405, the control unit 101 sets the learning label 808 to “does not appear”. Similarly, when the difference length of the difference deformation data is less than the length input to the difference minimum length input region 406, the control unit 101 sets the learning label 808 to “does not appear”.

### Confirmation of Learning Data

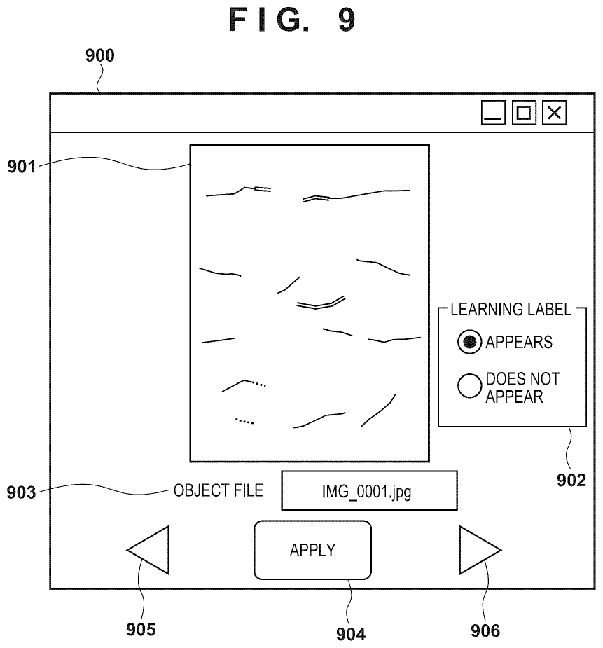

FIG. 9 illustrates a confirmation screen 900 of learning data. The confirmation screen 900 is a screen for confirming and editing the learning data created in S505. The confirmation screen 900 includes a learning data display region 901, a learning label region 902, an object file display region 903, an application button 904, a display change button 905, and a display change button 906.

The learning data display region 901 displays an image in which difference deformation data that is a difference calculation result is superimposed on the first inspection image. In the learning data display region 901, a deformation appearing as extension or new, that is, a difference of the deformation is drawn by a double line.

The learning label region 902 displays a learning label corresponding to the image displayed in the learning data display region 901. The user can change the learning label by confirming the image or the calculation result of the difference deformation data and selecting the button in the learning label region 902.

The object file display region 903 displays a file name of the image used for creation of the displayed learning data among the plurality of learning data.

The application button 904 is a button for reflecting the item of the learning label changed by the user in the learning label region 902 into the image of the learning data display region 901. When the user operates the application button 904 after changing the learning label in the learning label region 902, the control unit 101 changes the item of the learning label 808 of the corresponding learning data in the learning data table 801.

The display change button 905 and the display change button 906 change the learning data displayed in the learning data display region 901 and the display content of the learning label region 902 and the object file display region 903. For example, when the user operates the display change button 905 and the display change button 906, the control unit 101 changes the learning data displayed in the learning data display region 901 in the order of the image files of the learning data table 801. In accordance with the change, the control unit 101 changes the display content of the learning label region 902 and the object file display region 903 to the content associated with the changed learning data.

According to the present embodiment, it is possible to create learning data for causing, to learn, a learning model that can predict an appearance of a deformation based on difference deformation data that is a state change from deformation data of each of a first inspection image and a second inspection image that are not known and captured in two different timings with a same region as an inspection target.

In the present embodiment, using learning data in which a learning label is created from difference deformation data, learning of two-class classification is performed, and a learning model is created. An existing method may be used as the learning method of the two-class classification. Due to this, in the present embodiment, it is possible to predict an appearance of a deformation by using a learning model created with a captured image as input.

In the present embodiment, with the difference deformation selection switch 404, it is possible to select, for the learning object, whether the type of the difference deformation data is only deformation of extension, or whether a deformation of extension and the new are used. In the case of new deformation data appearing in a place where deformation data does not exist in an existing, i.e., the first inspection image, the first inspection image may have less texture information than difference deformation data of extension. Therefore, the present embodiment achieves creation of learning data enabling highly accurate learning, by providing the difference deformation selection switch 404 to be selectable whether to use only extension or to use also new.

In the present embodiment, in the difference minimum number input region 405 and the difference minimum length input region 406, the user can designate at least any of the number and the length of the difference deformation data. Due to this, in the present embodiment, in a case where the number of the difference deformation data is small or the length of the difference deformation data is short, the learning data can be excluded from learning as noise.

In the present embodiment, by displaying the confirmation screen 900 that is also editable, it is possible not only to collectively set the conditions in the difference deformation selection switch 404, the difference minimum number input region 405, and the difference minimum length input region 406, but also to individually change the learning label of the learning data ID. Due to this, in the present embodiment, it is possible to create learning data according to the desire of the user.

Note that in the present embodiment, when a misalignment occurs between the capturing region of the first inspection image and the capturing region of the second inspection image, it is possible to calculate difference deformation data with higher accuracy by correcting the misalignment. The processing method of misalignment correction may be applied with misalignment detection and correction of an existing matching method by applying matching between images, similarity between deformation lines of cracks, and the like.

In the present embodiment, the learning data is created by calculating the difference with respect to the deformation data of linear cracks, but the creation method of learning data is not limited to this. For example, in the present embodiment, learning data may be created by calculating a difference with respect to deformation data of a region having an area such as water leakage and rust fluids. In the difference calculation method of deformation data of a region type, the area of the second deformation data is compared with the area of the first deformation data, and a learning label is set depending on whether or not deformation data having a difference in area exists. In the difference deformation selection switch 404, in a case of extension with deformation data of a linear crack type, the present embodiment may be treated as a case where the region type deformation data is expanded (enlarged).

In learning data, learning may be added with any of information on time such as years or days between the first inspection image and the second inspection image and information on the type of structures such as tunnels or bridges. For example, when learning is performed by adding information on time to the learning data, the learning model can also estimate the timing of a scheduled appearance. By performing learning for each type using the type of the structure, the learning model can increase the prediction accuracy of appearance.

### Second Embodiment

In the first embodiment, an example of inputting the first inspection image and creating learning data for predicting an appearance of a deformation for the entire image has been described. In the second embodiment, an example will be described in which the control unit 101 divides an inspection image into a plurality of regions, assigns learning labels in units of the divided regions (patches), and classifies and creates learning data.

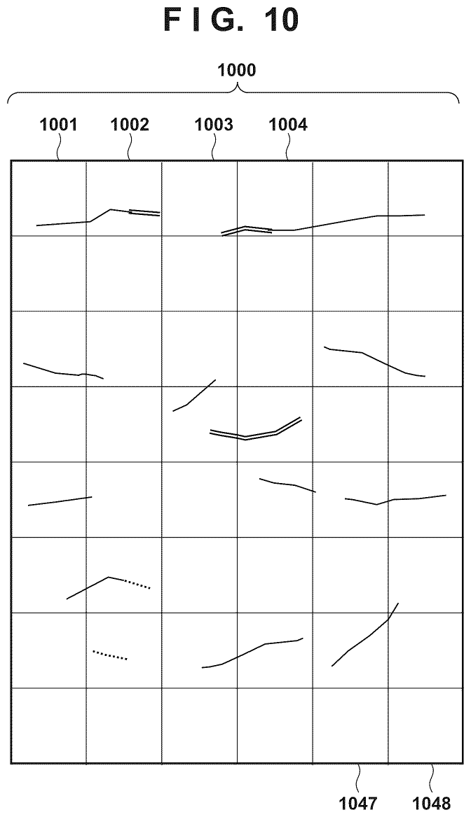

FIG. 10 illustrates an example of dividing, into patches, an image in which difference deformation data is superimposed on a first inspection image in the second embodiment. As illustrated in FIG. 10, for example, the control unit 101 divides, for each predetermined pixel, an image (learning data) in which the difference deformation data is superimposed on the first inspection image. In the present embodiment, the control unit 101 divides the image into 48 patches by dividing the image into six in the horizontal direction and eight in the vertical direction for every 500 pixels. The image includes patches 1001 to 1048.

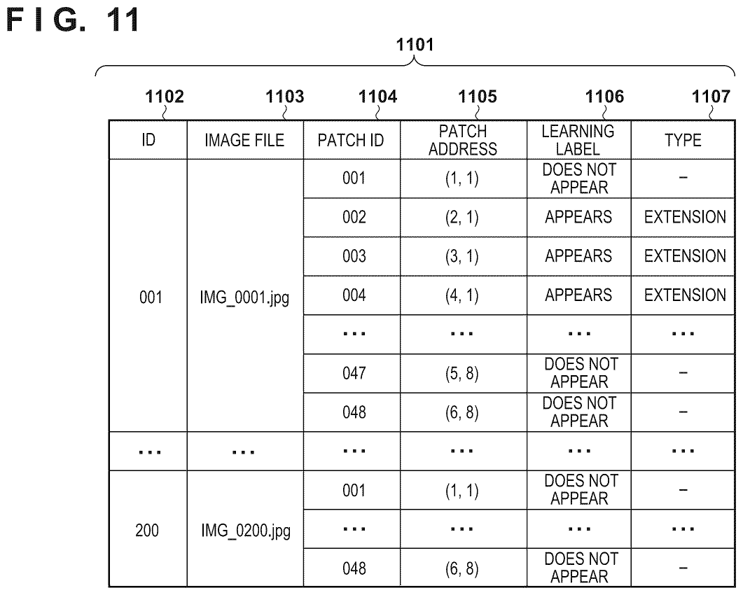

FIG. 11 is a learning data table 1101 in the second embodiment. The learning data table 1101 includes an ID 1102 for identifying images, an image file 1103, a patch ID 1104, a patch address 1105, a learning label 1106, and a type 1107.

The image file 1103 indicating the first inspection image, the learning label 1106, and the type 1107 are similar to those of the learning data table 801 of the first embodiment. However, the learning label 1106 and the type 1107 are associated with not the learning data but respective patches. The control unit 101 sets “appears” in the learning label 1106 of the patch including the double line in the difference deformation data of FIG. 10.

The patch ID 1104 indicates an ID for identifying the divided patches. For example, the patch ID of the patch 1001 in FIG. 10 is “001”. The patch ID of the patch 1048 in FIG. 10 is “048”. The learning data may be identified by a combination of the ID 1102 and the patch ID 1104, for example. In other words, the identification information of the learning data may be “ID 1102” + “patch ID 1104”.

The patch address 1105 indicates address values in the horizontal direction and the vertical direction from the upper left of the image of the division source. For example, the patch address 1105 of the patch 1001 in FIG. 10 is (1, 1). The patch address 1105 of the patch 1048 in FIG. 10 is (6, 8).

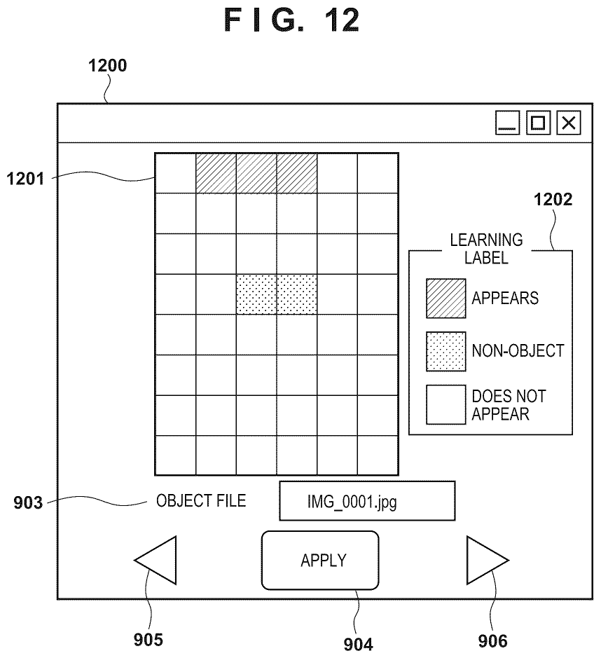

FIG. 12 illustrates a confirmation screen 1200 in the second embodiment. The control unit 101 displays, in a learning data display region 1201, hatching indicating a learning label associated with learning data of the learning data table 1101 in a patch of a corresponding patch address. The learning label 1202 of each patch includes “non-object” in addition to “appears” and “does not appear”. The “non-object” is a patch set as being not an object of the learning data even if difference deformation data exists.

As described above, in the second embodiment, the control unit 101 divides an object image of learning data into a plurality of patches, and creates the learning data by assigning a learning label to each patch. Due to this, in the present embodiment, it is possible to increase the learning data necessary for learning, and it is possible to improve the estimation accuracy using the learning model for prediction appearance that is generated. As the learning method, a patch whose learning label is “non-object” may be excluded from the object of the learning data as “does not appear”, and learning of two-class classification may be performed similarly to the first embodiment.

In the present embodiment, when an image is divided as a patch with a predetermined number of pixels, there may be an image part with less than a predetermined number of pixels. For example, when the control unit 101 divides an image into 500 pixels to generate a patch, the pixels of the width and the pixels of the height of the inspection image of the division object are often not multiples of 500. In this case, the control unit 101 may have the patch creation object in the center portion of the inspection image and set the peripheral portion of the inspection image as a non-target region of the patch. In a case where there is a deviation in the appearance position of the difference deformation data in the inspection image, the control unit 101 may create a patch so as to include the difference deformation data appearing in the peripheral portion in order to increase the number of data of the learning object.

### Third Embodiment

In the above embodiments, examples have been described in which the learning data is created based on the information as to whether or not difference deformation appears in the first inspection image. In the third embodiment, an example in which the first inspection image and the difference deformation data are used as learning data will be described. For example, in the third embodiment, learning data is created in units of difference deformation data.

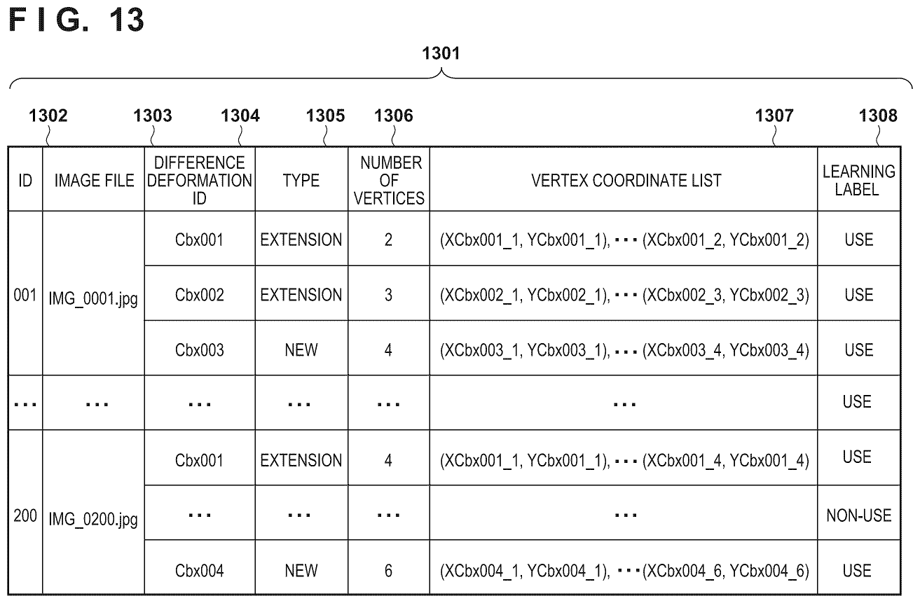

FIG. 13 is a learning data table 1301 in the third embodiment. The learning data table 1301 includes an ID 1302 for identifying images, a first inspection image file 1303, a difference deformation ID 1304, a type 1305, a number of vertices 1306, a vertex coordinate list 1307, and a learning label 1308.

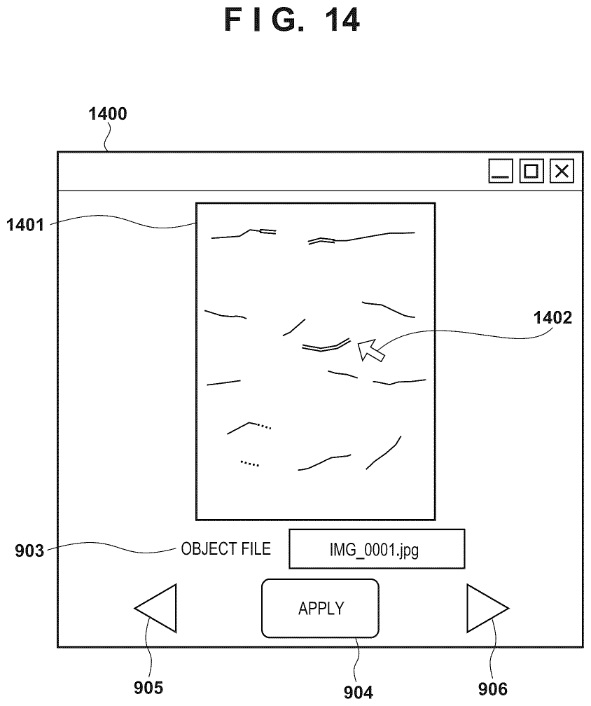

FIG. 14 is a confirmation screen 1400 in the third embodiment. The control unit 101 displays, in a learning data display region 1401, an image in which the difference deformation data indicated by a double line is superimposed on the first inspection image. A pointer 1402 is a UI for the user to set whether the difference deformation data displayed by the double line is to be an object of the learning label. The user operates the pointer 1402 to designate any of the difference deformation data, and designates whether to use or not to use the difference deformation data as learning data. Based on the designation by the user, the control unit 101 sets, in the learning label 1308, whether or not to use the difference deformation data as learning data.

As described above, in the third embodiment, it is possible to estimate deformation data that will appear in the future when prediction estimation is performed with an image as input using the learning model generated by learning prediction of deformation using the difference deformation data itself as learning data with respect to the first inspection image. The learning method may be an existing machine learning method, and learning for detecting deformation in units of pixels may be performed using the method described in Izumi Document.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The above embodiments may be combined. For example, the first, second and third embodiments may be combined and made available for users to select.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002045, filed Jan. 10, 2024, which is hereby incorporated by reference herein in its entirety.

What is claimed is:

1. An information processing apparatus comprising:
one or more processors; and
one or more memories including instructions that, when executed by the one or more processors, cause the information processing apparatus to:
acquire first deformation data indicating a deformation included in a first inspection image obtained by capturing a first region, and second deformation data indicating a deformation included in a second inspection image obtained by capturing a second region including at least a part of the first region at a timing newer than a timing at which the first inspection image is captured;
calculate difference deformation data indicating a difference between the first deformation data and the second deformation data; and
create learning data for causing, to learn, a model that predicts an appearance of the deformation based on the difference deformation data.

2. The information processing apparatus according to claim 1, wherein
in creation of the learning data, the learning data is created in units of inspection images based on the difference deformation data.

3. The information processing apparatus according to claim 1, wherein
in creation of the learning data, the learning data is created in units of regions obtained by dividing an inspection image based on the difference deformation data.

4. The information processing apparatus according to claim 1, wherein
in creation of the learning data, the learning data is created in units of the difference deformation data based on the difference deformation data.

5. The information processing apparatus according to claim 1, wherein
in creation of the learning data, the learning data is classified and created based on the difference deformation data.

6. The information processing apparatus according to claim 1, wherein
in creation of the learning data, the learning data is created based on a type of the second deformation data with respect to the first deformation data associated with the difference deformation data.

7. The information processing apparatus according to claim 1, wherein
in creation of the learning data, the learning data is classified and created based on a number of pieces of difference deformation data.

8. The information processing apparatus according to claim 1, wherein
in creation of the learning data, the learning data is classified and created based on a length of pieces of difference deformation data.

9. The information processing apparatus according to claim 1, wherein
in creation of the learning data, the learning data is displayed.

10. The information processing apparatus according to claim 1, wherein
in creation of the learning data, the learning data is edited based on a learning data instruction received from a user.

11. The information processing apparatus according to claim 1, wherein
in calculation of the difference deformation data, a misalignment between the first inspection image and the second inspection image is corrected, and the difference deformation data is calculated.

12. The information processing apparatus according to claim 1, wherein
in calculation of the difference deformation data, the second deformation data existing outside an expansion range where the first deformation data is expanded in a width direction is calculated as the difference deformation data.

13. The information processing apparatus according to claim 6, wherein
in creation of the learning data, the type of the second deformation data is set based on an overlap between the first deformation data and the second deformation data.

14. An information processing method comprising:
acquiring first deformation data indicating a deformation included in a first inspection image obtained by capturing a first region, and second deformation data indicating a deformation included in a second inspection image obtained by capturing a second region including at least a part of the first region at a timing newer than a timing at which the first inspection image is captured;
calculating difference deformation data indicating a difference between the first deformation data and the second deformation data; and
creating learning data for causing, to learn, a model that predicts an appearance of the deformation based on the difference deformation data.

15. A non-transitory computer-readable storage medium storing a computer program that, when read and executed by a computer, causes the computer to function as
an acquisition unit that acquires first deformation data indicating a deformation included in a first inspection image obtained by capturing a first region, and second deformation data indicating a deformation included in a second inspection image obtained by capturing a second region including at least a part of the first region at a timing newer than a timing at which the first inspection image is captured,
a calculation unit that calculates difference deformation data indicating a difference between the first deformation data and the second deformation data, and
a creation unit that creates learning data for causing, to learn, a model that predicts an appearance of the deformation based on the difference deformation data.
